(19) United States
(12) Patent Application Publication
(10) Pub. No.: US 2005/0140613 A1
(43) Pub. Date: Jun. 30, 2005

(54) Tiled display with filter for uniform pixel brightness

(76) Inventors: Anthony Cyril Lowe, Hampshire (GB); Paul Andrew Bayley, Hereford (GB); Barbara Needham, Baldock (GB)

Correspondence Address: RADER FISHMAN & GRAUER PLLC, LION BUILDING, 1233 20TH STREET N.W., SUITE 501, WASHINGTON, DC, 20036, US

(21) Appl. No.: 10/503,571

(22) PCT Filed: Feb. 5, 2003
(86) PCT No.: PCT/GB03/00477

(30) Foreign Application Priority Data
Feb. 6, 2002 (GB) 02027829

(51) Int. Cl. G09G 3/36

(52) U.S. Cl. 345/87

(57) ABSTRACT

An image display comprises an image display device having an array of electrically driven picture elements (60) viewable at a viewing surface (90); and luminance correction means (110) arranged with respect to the image display device so as to apply a spatial luminance filter (122, 124) to the output of the image display device, the spatial luminance filter attenuating the light output by each picture element of the image display device in substantially inverse relation to the luminance response characteristics of the picture element so that each picture element exhibits substantially the same luminance for a given input electrical driving signal.

This invention relates to displays.

The technology behind flat-panel displays, such as liquid crystal or plasma displays, has advanced to the stage where a single display can be economically manufactured to about the screen size of a modest domestic television set. To increase the display size of a single-unit display beyond this level introduces dramatically greater costs, much lower manufacturing yields and other significant technical problems.

To provide larger displays, therefore, a hybrid technology has been developed whereby multiple smaller rectangular displays are tessellated to form the required overall size. For example, a 2×2 tessellated array of 15 inch diagonal displays, with appropriate addressing electronics to route picture information to the appropriate sub-display, would provide a 30 inch diagonal display.

As an example, U.S. Pat. No. 4,139,261 (Hilsum) uses a wedge structure image guide formed of a bundle of optical fibres to expand the image generated by a panel display so that by abutting the expanded images, the gap between two adjacent panels, formed of the two panels' border regions, is not visible. This allows a substantially continuous image to be seen by the user even though the individual flat panels themselves have small non-displaying borders around them to carry electrical connections and the like. Other image guides formed in this way may translate the image to provide a border-less abutment between a pair of adjacent panels.

This invention provides an image display comprising:
an image display device having an array of electrically driven picture elements viewable at a viewing surface; and
optical luminance correction means arranged with respect to the image display device so as to apply a spatial luminance filter to the output of the image display device, the spatial luminance filter attenuating the light output by each picture element of the image display device in substantially inverse relation to the luminance response characteristics of the picture element so that each picture element exhibits substantially the same luminance for a given electrical driving signal.

This invention also provides an image display system having a plurality of abutting image displays as defined above, the luminance correction means for each image display being arranged so that, from image display to image display, each picture element exhibits substantially the same luminance for a given input electrical driving signal.

The invention recognises and addresses a drawback of displays, and particularly of multiple-panel (tiled) displays including those where the individual panels are arranged so as to abut and provide a substantially continuous image. That drawback is the inherent variation in luminance across the display panels.

The brightness uniformity across the surface of a displayed image is very important to the perceived quality of the image. Display manufacturers take great trouble to ensure, for example, that a display backlight provides a near-uniform illumination across a liquid crystal display. In systems having a single display panel, the brightness uniformity can be improved by various known techniques such that it is hard, though by no means impossible, for a user to detect any variations by eye.

However, in a tiled display the situation is rather different. Brightness variations become highly visible and subjectively disturbing when they occur at the boundary between two adjacent panels. In many ways, the edges of a backlit panel are the hardest places to maintain brightness uniformity, because it is hard to obtain a uniform backlight at the extremes of the panel.

The invention addresses this problem of brightness non-uniformity from panel to panel in an elegantly simple manner by providing a uniformity correction at each panel. Accordingly, the invention is applicable to individual panels as well as to a tiled display formed of many panels.

Although the luminance correction means could be an optical spatial filter placed practically anywhere in the optical system of the display (e.g. at the output of a backlight, within a lens system etc), in a preferred embodiment the luminance correction means comprises an optical spatial filter disposed over the viewing surface of the image display device. This has the advantage that the luminance correction means can be set up, altered or replaced after installation of the display and without disturbing the component parts of the display. It is highly preferable however, to ensure that the luminance correction means does not cause a spatial variation in the ambient reflectivity of the front display screen. In another preferred embodiment, each picture element comprises a substantially contiguous group of display elements; and the luminance correction means comprises a masking arrangement disposed so as to obscure a subset of the display elements in the groups corresponding to at least some picture elements.

The invention is particularly applicable to an image display in which each picture element comprises a group of primary colour elements to provide red, green and blue illumination.

In the case of an image display using an image guide having an array of light transmission guides, input ends of the light transmission guides being arranged to receive light from picture elements of the image display device, and output ends of the light transmission guides providing an image output surface, it is preferred that the luminance correction means comprising an optical spatial filter disposed at the input ends of the light transmission guides. This has the advantage that the light guides tend to homogenise the light presented at their input, so the effect of the luminance correction means (apart from its desired effect of luminance control) would be less visible to the viewer.

Preferably the optical spatial filter comprises a substantially transparent substrate carrying markings, the density and/or hue and/or saturation of the markings at spatial positions on the substrate providing a required degree of optical attenuation at those spatial positions. In one embodiment, the markings are arranged so as to partially obscure the light from a picture element, the amount of obscuration and/or the hue of the markings and/or the saturation of the markings providing the required degree of attenuation. This has the advantage that it is easier to print with the required degrees of accuracy and resolution a combination of high resolution spatial detail and high resolution grey scale onto a substrate than by using either spatial detail or grey scales alone. So, a desired degree of attenuation can be obtained more accurately by using markings which partially obscure the light.

Preferably, when only the luminance requires correction, to avoid an unwanted effect on the hue generated by the picture elements, the markings are grey in hue and provide equal levels of spatial obscuration of the red, green and blue picture elements.

Preferably, in the case where hue and luminance correction are required, the markings are grey in hue, but obscure unequal levels of obscuration of the red green and blue picture elements.

The invention also provides a method of fabricating an optical luminance correction filter to apply a spatial luminance filter to the output of an image display device having a plurality of electrically driveable picture elements, the spatial luminance filter attenuating the light output by each picture element of the image display device in substantially inverse relation to the luminance response characteristics of the picture element so that each picture element exhibits substantially the same luminance for a given input electrical driving signal; the method comprising the steps of:
driving all of the picture elements with an identical electrical driving signal;
detecting the output luminance at different spatial positions at the viewing surface; and
generating an optical spatial filter having an optical attenuation in inverse relation to the detected luminance.

Preferably the identical electrical driving signal is an electrical driving signal corresponding to a substantially full luminance level. This can give the maximum variation between picture elements and so a more accurately generated correction filter.

In some cases, it is possible that spatial variations in contrast ratio exist across the image display. In this case, it is possible for the display to have uniform luminance when addressed with one input electrical signal (for example, at the maximum luminance level), but to exhibit spatial non-uniformity at another luminance level. In this event, it will be impossible to ensure uniform luminance at all grey levels by using an optical spatial filter. However, it may be preferred to generate the optical spatial filter having optical attenuation in inverse relation to the spatial luminance variation at an intermediate luminance level. In the case where the luminance correction means is an electrical signal processing apparatus, satisfactory luminance correction at all luminance levels will be possible.

For ease of use, preferably the detecting step comprises photographing (using digital or film media) a viewing surface of the image display device.

Various other respective aspects and features of the invention are defined in the appended claims. Features from the dependent claims may be combined with features of the independent claims as appropriate and not merely as explicitly set out in the claims.

Embodiments of the invention will now be described, by way of example only, with reference to the accompanying drawings in which:

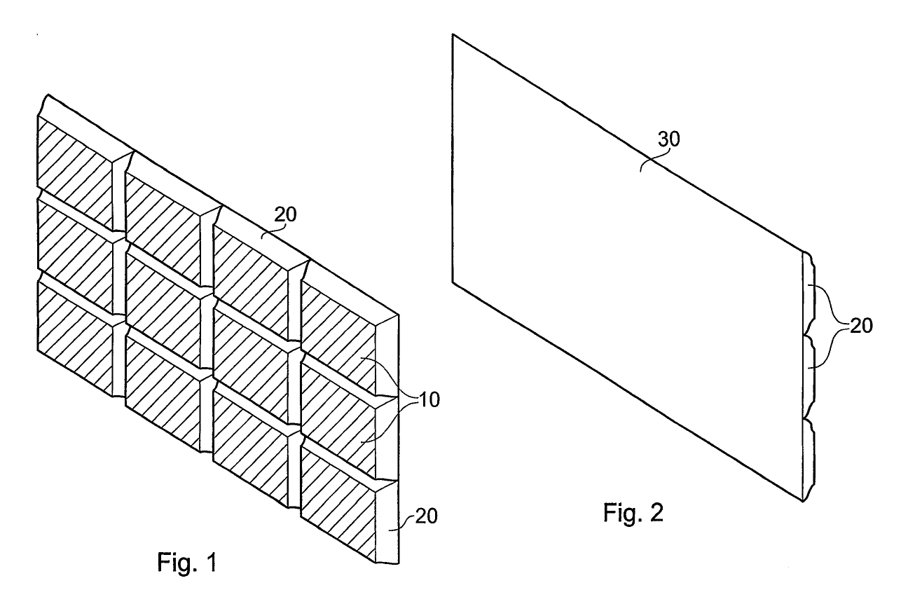

FIG. 1 is a schematic isometric rear view of a tiled array of display panels;

FIG. 2 is a schematic isometric front view of the array of FIG. 1;

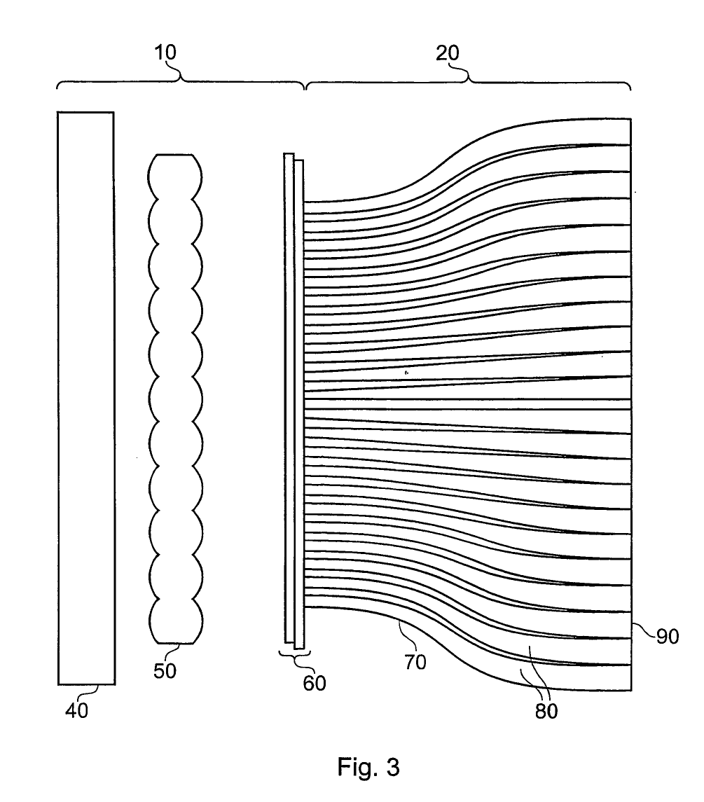

FIG. 3 is a schematic side view of a display comprising a light source, a homogeniser, a display panel and an image guide;

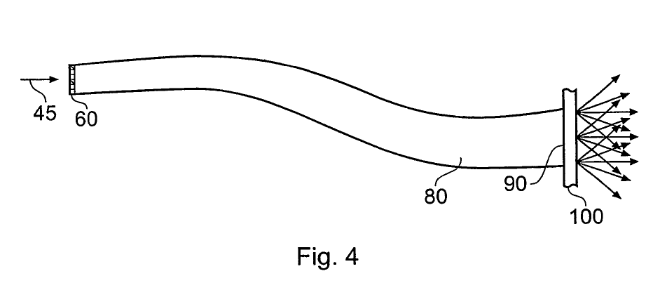

FIG. 4 is a schematic side view of a light transmission guide;

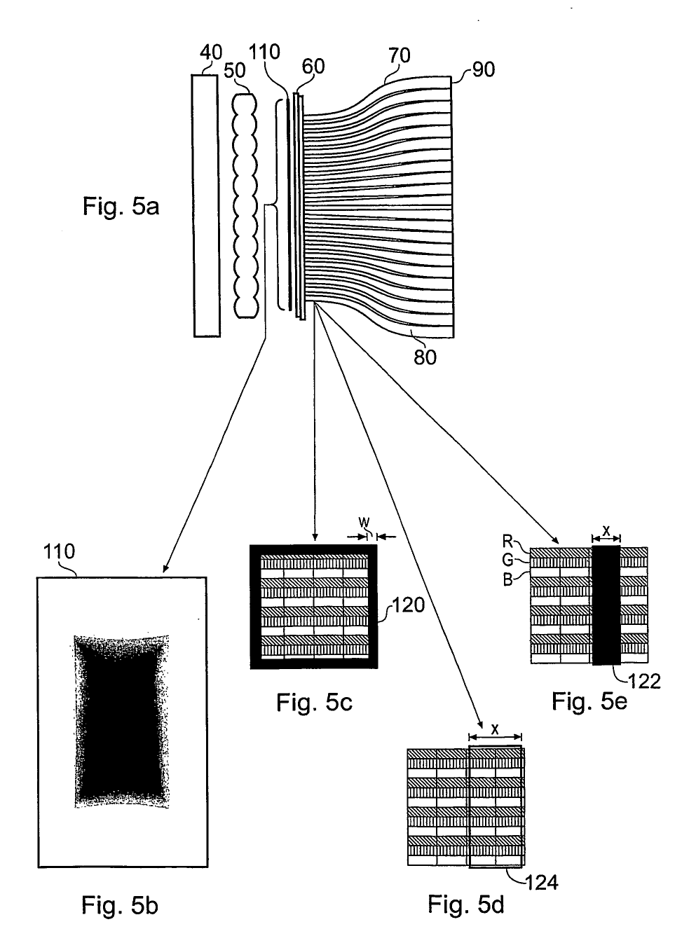

FIGS. 5a to 5e schematically illustrate techniques for optical correction of luminance levels across a display; and

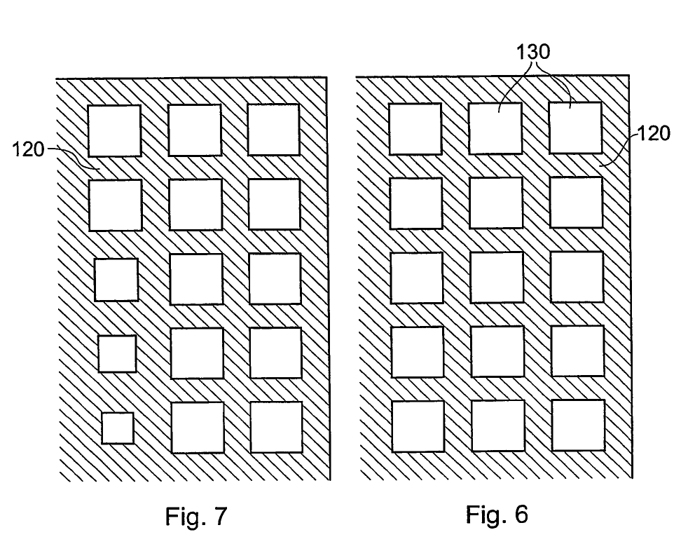

FIGS. 6 and 7 schematically illustrate the arrangement of FIG. 5c in greater detail.

FIG. 1 is a schematic isometric rear view of a tiled array of display panels.

The array comprises four display panels in a horizontal direction and three display panels in a vertical direction. Each display panel comprises a light emitting surface 10 and an image guide 20.

The light emitting surfaces 10 are each arranged as a plurality of pixels or picture elements. In practice, they might include, for example, a back light arrangement, focusing, collimating and/or homogenising optics and a liquid crystal panel or the like, but much of this has been omitted for clarity of the diagram.

The light emitting panels each display portions of an overall image to be displayed. The portions represent adjacent tiles in a tessellated arrangement. However, because of the need to run electrical connections and physical support around the edge of the light emitting surfaces 10, they cannot be directly abutted without leaving a dark band or “black matrix” in between. So, the light guides 20 are used to increase the size of the image from each light emitting surface 10 so that the output surfaces of the light guides 20 can be abutted to form a continuous viewing plane.

This arrangement is shown in FIG. 2 which is a schematic isometric front view of the array of FIG. 1. Here, the output surfaces of the light guides 20 abut so as to form a continuous viewing surface 30.

FIG. 3 is a schematic side view of a display comprising a collimated light source 40, a homogeniser 50, a liquid crystal panel 60 and a light guide 70.

The collimated light source 40 and the homogeniser 50 are shown in highly schematic form but, in themselves, form part of the state of the art. The particular homogeniser which is schematically illustrated includes a so-called “fly's eye” type of lens to provide the back light required by the liquid crystal panel 60.

The liquid crystal panel 60 may be of a type which uses a white or other visible colour back light and provides liquid crystal picture elements to modulate that back light for that display. Alternatively, the liquid crystal panel 60 may be a photo luminescent panel which employs an ultra-violet back light and modulates the ultra-violet light onto an array of phosphors to generate visible light for display. Of course, many other types of light emitting surface 10 may be used such as an organic light emitting diode array.

The image guide 70 comprises an array of light transmission guides 80, each of which carries light from a particular area on the liquid crystal panel 60 to a corresponding particular area on an output surface 90. In doing so, the light transmission guides are arranged to diverge so that the area covered on the output surface 90 is physically larger than the image display area on the liquid crystal panel 60. This, as described above, allows an array of displays as shown in FIG. 3 to be abutted without an unsightly black matrix at the viewing plane.

FIG. 4 is a schematic side view of a light transmission guide 80. The light transmission guide 80 as shown is similar in function to an optical fibre, having an internal core surrounded by cladding material (even air), the core and the cladding having appropriate refractive indices so as to cause total internal reflection within the optical fibre. Alternatively, the guide 80 may be in the form of a hollow tube having a reflecting inner surface, so that light within the guide undergoes multiple specular reflections as it passes along the guide. In another alternative, the guide could be formed of a solid transparent material such as glass or a plastics material but have a reflecting outer surface or coating, for example a coating of a metal such as silver or aluminium. Again, this would lead to multiple internal specular reflections as light passes along the guide.

So, in operation, illumination from the back light 40 and the homogeniser 50 passes through picture elements of the display panel 60 before entering the guide 80. The light passes along the guide and towards its output 90. In the drawing, this is shown as propagation from the left to the right of the drawing. The output end of the guide forms a viewing surface and may be covered by a diffuser panel 100.

FIGS. 5a to 5e schematically illustrate techniques for optical correction of luminance levels across a display.

FIG. 5a is based on a reduced size drawing of FIG. 3. However, it includes various features which can be used, either individually or together, to provide a uniform (or at least more uniform) luminance across the display. In particular, FIG. 5b schematically illustrates a mask filter 110 which could be placed between the homogeniser 50 and the display panel 60, between the display panel 60 and the image guide 70, or even at the viewing surface 90 of the image guide 70. In FIG. 5a the screen is shown between the homogeniser and the display panel. This is perceived to be the most convenient place to put it from a manufacturing point of view, in that it does not interfere with bonding of the display panel to the image guide 70, and from an aesthetic point of view in that it does not become visible in its own right to the user, as it might if it were placed at the output viewing plane 90.

The screen 110 is printed or otherwise marked with grey scale or other markings so that the markings are more attenuating at regions of the display where the luminance response of the display is higher. Typically, the luminance response is higher towards the centre of the display, so the schematic example in FIG. 5b shows darker or more dense markings towards the centre of the screen 110. Similarly, the usual place for the luminance response to be lower is towards the periphery of a display, so the schematic example shown in FIG. 5b has less dense or lighter markings towards the edge of the screen 110.

In practice, if the luminance response were being made more uniform across only a single display, the screen 110 would be arranged to give as little attenuation as possible at those positions on the display at which the luminance response (before correction) were lowest. However, if the luminance response is being made more uniform over an abutting array of displays, it may be necessary that the overall response of at least some of the displays is attenuated down to the level of the lowest-response display. In that case, some of the screens 110 may be attenuating across their whole area.

FIGS. 5c to 5e schematically illustrate other measures which can be used to attenuate selective areas of the display 60. In particular, FIGS. 5c to 5e illustrate techniques for attenuating the output of a sub-array of picture elements forming the input to a single light guide 80.

In FIGS. 5c to 5e, there is shown a sub-array of 4×4 picture element groups which form the input to a single light guide 80 (and therefore represent a single “output” picture element for viewing at the viewing surface 90). Each picture element group comprises a red picture element R, a green picture element G and a blue picture element B. So, in the entire sub-array forming the input to one light guide 80, there are 36 picture elements, being 12 each of the red, green and blue picture elements.

FIG. 5c schematically illustrates a darkened border 120 placed around the group of picture elements. The width w of the border may be varied so as to vary the attenuation provided to the array of picture elements. Care needs to be taken in doing this, however, to avoid disturbing the balance between the picture elements of different primary colours, unless hue correction is specifically required. This matter is illustrated in FIG. 5c in that, with the border 120 in place, there is now a predominance of green G (picture elements) contributing to the light propagating into the input of the light guide 80. So, if hue correction is not required, it is preferable that the width of the border W is so arranged that each of the three primary colours is attenuated equally. The density or grey level of the border 120 may then be adjusted to give the required degree of overall attenuation.

Of course, if there is a need to provide hue correction as well as luminance correction, then unequal amounts of attenuation can be provided to the different primary colours within the sub-array. Similarly, although printing grey scales has advantages in terms of obtaining an accurate degree of attenuation, it is possible to use attenuating markings of different hues if that is required in a particular application. For example, in a single-colour display it might be desirable to use markings of a complementary colour to the display colour.

It will be appreciated that colours other than red, green and blue can be used. The term “primary colours” is simply used to denote a set of colours in a sub-array which provide a contribution to the output of that “output pixel”, i.e. the output of the corresponding light transmission guide.

FIGS. 5d and 5e schematically illustrate a similar arrangement but using darkened stripes 122,124 to attenuate the light passing into the input of the light guide 80. The stripes are arranged so as to cover the three primary colour picture elements equally. The width x and the density or grey level of the stripe may then be set so as to provide the required degree of attenuation.

FIGS. 6 and 7 schematically illustrate the arrangement of FIG. 5c in more detail. In particular, FIG. 6 shows an example of one part of a display panel in which individual arrays of picture elements 130, each array 130 feeding a single light guide 80, are separated by a darkened border 120. In FIG. 6, the border 120 has a uniform width. For luminance level control, however, the width is varied as shown in FIG. 7, where more attenuation is provided towards the centre of the display (schematically shown as the lower left corner of FIG. 7).

In the above embodiments, a perceived aim has been to obtain a more uniform luminance response across a single display or between displays in a tiled or tessellated arrangement. In order to achieve this, it is appropriate that the luminance correction means (whichever embodiment is in use) should apply a correction which is substantially the inverse of the luminance response of the or each display.

There are various ways of detecting the luminance response of a display. For example, the display could be driven with an electrical signal representing a particular luminance level (e.g. white at full luminance) and a photodetector tracked over the surface of the display using a stepper motor arrangement. The photodetector and associated control apparatus would record the luminance level at each spatial position of the display, subject to the spatial resolution being dependent on the size of the photodetector.

In an elegantly simple embodiment, however, the display is driven with an appropriate luminance level and then photographed in an appropriately darkened environment. If the photograph is with a digital camera, then the pixel information of the captured image requires only relatively simple processing to give the correction information for the above embodiments.

If the luminance response of a display is non-linear (i.e. the contrast ratio varies) then the above process can be carried out at a suitable intermediate luminance level such as half or ⅔ luminance to obtain a reasonable correction across the whole range of luminance levels.

If it is required to obtain uniform luminance response between displays in a tiled arrangement, for example, then the above measurement process is carried out on each display, using an identical electrical driving signal from display to display. The correction factor to be applied at each position is then derived as L/p, where L is the lowest measured luminance level across the group of displays, and p is the recorded level at the position to be corrected.

1. An image display play comprising:
an image display device having an array of electrically driven picture elements viewable at a viewing surface; and
optical luminance correction means arranged with respect to the image display device so as to apply a spatial luminance filter to the output of the image display device, the spatial luminance filter attenuating the light output by each picture element of the image display device in substantially inverse relation to the luminance response characteristics of the picture element so that each picture element exhibits substantially the same luminance for a given input electrical driving signal.

2. An image display according to claim 1, comprising an image guide having an array of light transmission guides, input ends of the light transmission guides being arranged to receive light from picture elements of the image display device, and output ends of the light transmission guides providing an image output surface.

3. An image display according to claim 1, in which the luminance correction means comprises an optical spatial filter disposed over the viewing surface of the image display device.

4. An image display according to claim 2, in which the luminance correction means comprises an optical spatial filter disposed over the image output surface of the image guide.

5. An image display according to claim 2, in which the luminance correction means comprising an optical spatial filter disposed at the input ends of the light transmission guides.

6. An image display according to claim 5, in which:
each picture element comprises a substantially contiguous group of display elements;
the optical spatial filter comprises a masking arrangement disposed so as to obscure a subset of the display elements in the groups corresponding to at least some picture elements.

7. An image display according to claim 5, in which the optical spatial filter comprises a substantially transparent substrate carrying markings, the density and/or hue and/or saturation of the markings at spatial positions on the substrate providing a required degree of optical attenuation at those spatial positions.

8. An image display according to claim 7, in which the markings are arranged so as to partially obscure the light from a picture element, the amount of obscuration and/or the hue of the markings and/or the saturation of the markings providing the required degree of attenuation.

9. An image display according to claim 7, in which the markings are grey in hue.

10. An image display according to claim 8, in which each picture element comprises a group of n primary colour elements, where n is at least 1.

11. An image display according to claim 10, in which the group of primary colour elements provides red, green and blue illumination.

12. An image display according to claim 10, in which the markings are arranged to provide substantially equal attenuation to each primary colour within a picture element.

13. An image display according to claim 10, in which the markings are arranged to provide unequal attenuation to each primary colour within at least some of the picture elements so as to provide a hue correction to the picture elements.

14. An image display system having a plurality of abutting image displays according to claim 1, the luminance correction means

14. An image display system having a plurality of abutting image displays according to claim 1, the luminance correction means for each image display being arranged so that, from image display to image display, each picture element exhibits substantially the same luminance for a given input electrical driving signal.

15. A method of fabricating a luminance correction filter to apply a spatial luminance filter to the output of an image display device having a plurality of electrically driveable picture elements, the spatial luminance filter attenuating the light output by each picture element of the image display device in substantially inverse relation to the luminance response characteristics of the picture element so that each picture element exhibits substantially the same luminance for a given input electrical driving signal; the method comprising the steps of.
driving all of the picture elements with an identical electrical driving signal;
detecting the output luminance at different spatial positions at the viewing surface; and
generating an optical spatial filter having an optical attenuation in inverse relation to the detected luminance.

16. A method according to claim 15, in which the identical electrical driving signal is an electrical driving signal corresponding to a substantially full luminance level.

17. A method according to claim 15, in which the identical electrical driving signal corresponds to a non-zero luminance level other than a full luminance level.

18. A method according to any one of claims 15 to 17, in which the detecting step comprises photographing a viewing surface of the image display device.
